(19) United States
(12) Patent Application Publication
(10) Pub. No.: US 2023/0222544 A1
(43) Pub. Date: Jul. 13, 2023

(54) ANALYSIS DEVICE

(71) Applicant: NTT DOCOMO, INC., Chiyoda-ku (JP)

(72) Inventors: Yoshitaka INOUE, Chiyoda-ku (JP); Kenji SHINODA, Chiyoda-ku (JP); Noriaki HIROKAWA, Chiyoda-ku (JP); Manami KAWASAKI, Chiyoda-ku (JP)

(73) Assignee: NTT DOCOMO, INC., Chiyoda-ku (JP)

(21) Appl. No.: 18/000,311

(22) PCT Filed: May 19, 2021
(86) PCT No.: PCT/JP2021/019033

§ 371 Date: Nov. 30, 2022

(30) Foreign Application Priority Data
Jun. 2, 2020 (JP) 2020-096117

(51) Int. Cl. G06Q 30/0251; G06Q 10/04

(52) U.S. Cl. CPC G06Q 30/0255; G06Q 10/04

(57) ABSTRACT

An analysis device includes: a relationship construction unit configured to construct a relationship between a product and an advertiser by using the number of common users as a link based on user purchase histories of the product and user browsing histories of an advertisement associated with the advertiser; and a clustering unit configured to cluster the product and the advertiser together into a cluster based on the relationship between the product and the advertiser constructed by the relationship construction unit, wherein the number of common users is the number of users purchased the product and browsed the advertisement associated with the advertiser for the product and the advertiser linked to each other.

### TECHNICAL FIELD

One aspect of the present disclosure relates to an analysis device.

### BACKGROUND ART

Patent Literature 1 discloses a totalizing system. The totalizing system includes a first totalizing device and a second totalizing device. The first totalizing device includes a classification ID acquisition unit acquiring a classification ID (Identifier) of a consumer, a purchased product ID acquisition unit acquiring a purchased product ID of a product or a service, and an analysis unit totalizing the classification IDs and the purchased product IDs and analyzing first totalizing information indicating a distribution of the classification IDs with respect to the purchased product IDs. The second totalizing device includes a classification ID generation unit generating the classification ID based on a frequency of a predetermined behavior of the consumer and a calculation unit calculating second totalizing information indicating a distribution of the frequencies of the predetermined behavior for the purchased product ID based on first totalizing information input from the first totalizing device and the classification ID.

### CITATION LIST

### Patent Literature

Patent Literature 1: International Publication WO 2016/135784

### SUMMARY OF INVENTION

### Technical Problem

When distributing an advertisement to a user, the effect of the advertisement affected by distributing the advertisement to the user who has what kind of attributes. For example, when an advertisement for other products related to a specific product is distributed to users who are likely to purchase the specific product, the advertisement can be expected to have a certain effect. Therefore, the advertiser of the other product may be recommended to distribute the advertisement to the users who are likely to purchase the specific product. However, since the relationship between products is determined based on the human knowledge, it is conceivable that a user who is not necessarily appropriate may become a delivery destination.

One aspect of the present disclosure is to provide an analysis device capable of recommending appropriate users to advertisers.

### Solution to Problem

An analysis device according to one aspect of the present disclosure includes: a relationship construction unit configured to construct a relationship between a product and an advertiser by using the number of common users as a link based on user purchase histories of the product and user browsing histories of an advertisement associated with the advertiser; and a clustering unit configured to clustering the product and the advertiser together into a cluster based on the relationship between the product and the advertiser constructed by the relationship construction unit, wherein the number of common users is the number of users purchased the product and browsed the advertisement associated with the advertiser for the product and the advertiser linked to each other.

In the above analysis device, since the products and the advertisers are collectively clustered based on the relationship between the products and the advertisers constructed by using the number of common users as the link, the products and the advertisers can be associated with each other while human knowledge is excluded. In this case, it can be estimated that the users who have purchased a certain product are interested in the advertisement of the advertiser clustered together with the product. Therefore, the users appropriate for distribution of the advertisement can be recommended to the advertiser.

### Advantageous Effects of Invention

According to one aspect of the present disclosure, it is possible to provide an analysis device capable of recommending appropriate users to advertisers.

### BRIEF DESCRIPTION OF DRAWINGS

FIG. 1 is a block diagram illustrating a configuration of an analysis system including an example analysis device.

FIG. 2 is a diagram illustrating an example of a configuration of a user master database.

FIG. 3 is a diagram illustrating an example of a configuration of a product master database.

FIG. 4 is a diagram illustrating an example of a configuration of an advertiser master database.

FIG. 5 is a diagram illustrating an example of a configuration of an advertisement master database.

FIG. 6 is a diagram illustrating an example of a configuration of a product purchase log database.

FIG. 7 is a diagram illustrating an example of a configuration of an advertisement contact log database.

FIG. 8 is a diagram illustrating a relationship between a product and an advertiser constructed by a relationship construction unit.

FIG. 9 is a diagram illustrating a decomposition example of a matrix constructed by a relationship construction unit.

FIG. 10 is a diagram illustrating an example of an objective variable created by a data creation unit.

FIG. 11 is a diagram illustrating an example of an estimation result by an inference unit.

FIG. 12 is a flowchart illustrating an example of an operational flow of the analysis device.

FIG. 13 is a diagram illustrating an example of a hardware configuration of the analysis device.

### DESCRIPTION OF EMBODIMENTS

Exemplary embodiments are described in detail below with reference to the accompanying drawings. It is noted that, in the description of the drawings, the same or corresponding elements are denoted by the same reference numerals, and redundant descriptions thereof are omitted.

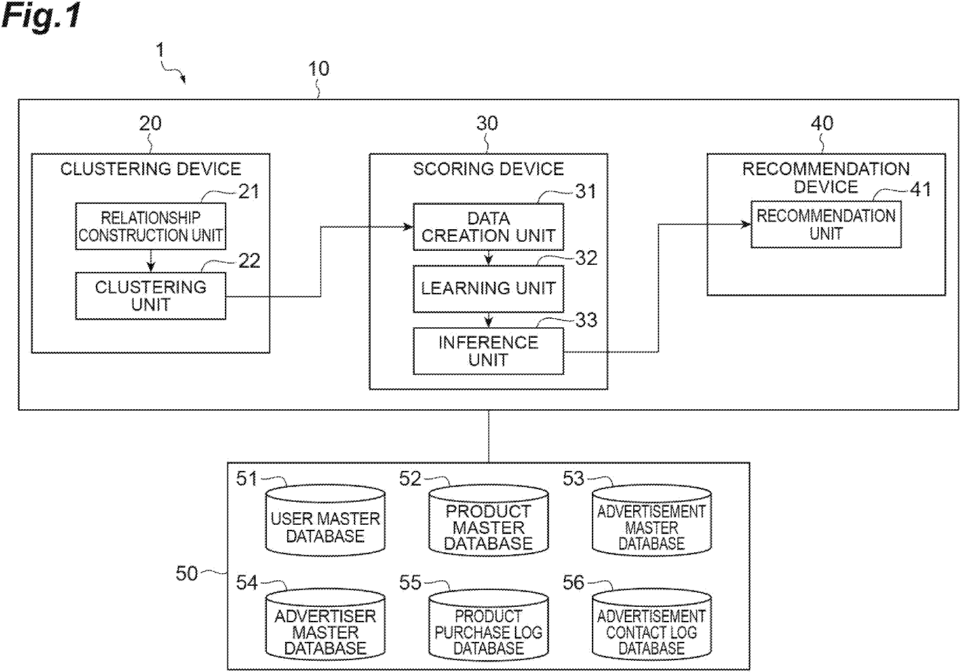

FIG. 1 is a diagram illustrating a functional configuration of an analysis system 1 including an analysis device 10 according to one example. The analysis system 1 includes the analysis device 10 and a database device 50. The analysis device 10 may be, for example, a server device that is configured to be communicable with the database device 50. The analysis device 10 may be configured by one device, or may be configured by a plurality of devices.

The analysis device 10 includes a clustering device 20, a scoring device 30, and a recommendation device 40. The analysis device 10 collectively clusters the product and the advertiser based on the relationship between the product and the advertiser by using the number of common users as the link, which is constructed based on the product purchase histories and the advertisement browsing histories of the users stored in the database device 50. As an example, the analysis device 10 may perform recommendation to the advertiser by using a group of users appropriate for transmitting the advertisement as a transmission target of the advertisement. A detailed description will be made below.

The database device 50 includes a user master database 51, a product master database 52, an advertisement master database 53, an advertiser master database 54, a product purchase log database 55, and an advertisement contact log database 56.

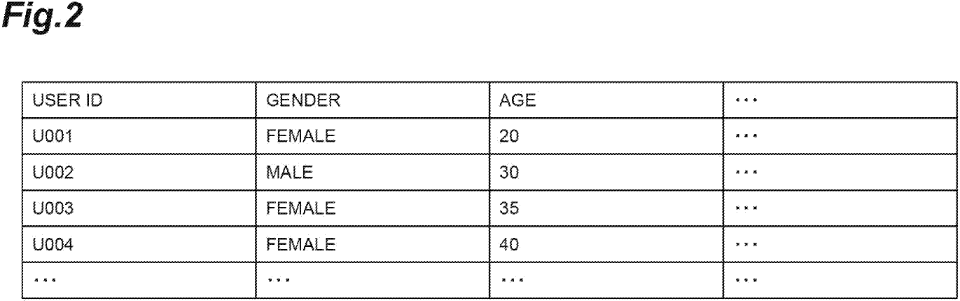

FIG. 2 is a diagram illustrating an example of a configuration of the user master database. The user master database 51 stores information indicating the attributes of each user as information on the users that are analysis targets of the analysis device 10. For example, the user master database 51 stores user IDs, which are identifiers for identifying each user and information indicating user attributes associated with the user IDs. The information indicating the user attributes may be, for example, gender, age, and the like. Furthermore, the information indicating the user attributes may include place of residence, occupation, and the like.

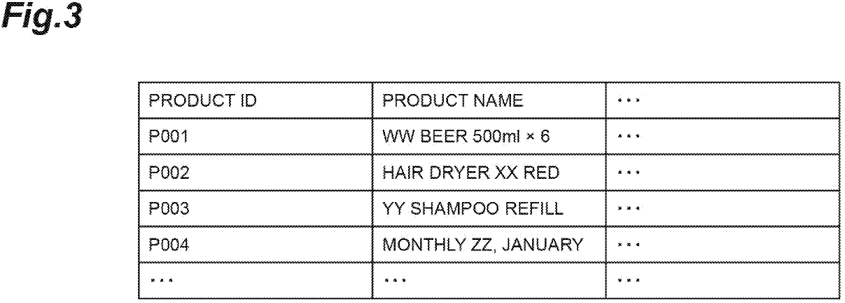

FIG. 3 is a diagram illustrating an example of a configuration of the product master database. The product master database 52 stores information on the products that are analysis targets of the analysis device 10. For example, the product master database 52 stores product IDs which are identifiers for identifying each product, and information on products associated with the product IDs. The information on the product may be, for example, the product name and the like. Furthermore, the information on the product may include a genre (type) of the product, a price of the product, and the like.

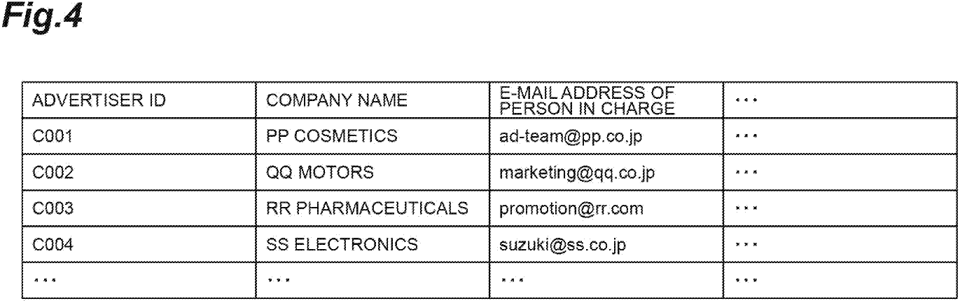

FIG. 4 is a diagram illustrating an example of a configuration of the advertiser master database. The advertiser master database 54 stores information on the advertisers that are analysis targets of the analysis device 10. For example, the advertiser master database 54 stores advertiser IDs which are identifiers for identifying each advertiser and information on the advertisers associated with the advertiser IDs. The information on the advertiser may be, for example, a company name, an e-mail address of a person in charge in an advertising department, and the like. Further, the information on the advertiser may include capital, advertising budget, and the like of a company which is an advertiser.

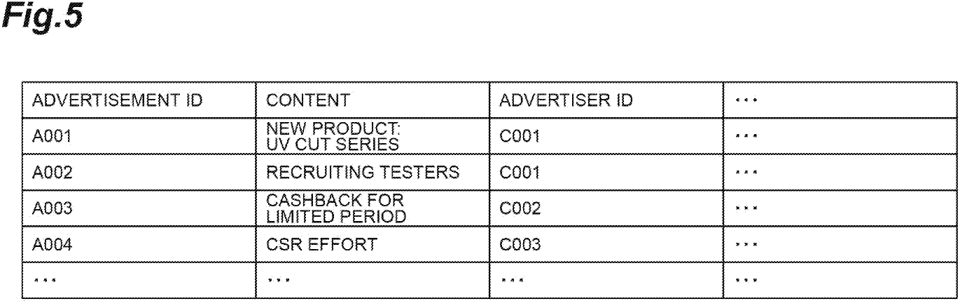

FIG. 5 is a diagram illustrating an example of a configuration of the advertisement master database. The advertisement master database 53 stores information on advertisement of the advertisers that are analysis targets of the analysis device 10. For example, the advertisement master database 53 stores advertisement IDs which are identifiers for identifying each advertisement, and information on the advertisements associated with the advertisement IDs. The information on the advertisement may be, for example, contents of the advertisements, the advertiser IDs of the advertisements, and the like. When the target of the advertisement is a product, the content of the advertisement may be a name of the product. Further, when the target of the advertisement is a service or the like, the content of the advertisement may be a keyword indicating the service or the like. The advertiser ID in the advertisement master database 53 may be common to the advertiser ID in the advertiser master database 54. Furthermore, the information on the advertisement may include a genre of the advertisement target, a price of the advertisement target, advertisement image data, and the like. It is noted that, in one example, the advertisement denotes an advertisement in a form in which the browsing by a user can be confirmed directly or indirectly and denotes an advertisement that can be distributed to a specific user as a target. As an example, the advertisement may be a WEB banner advertisement, a video advertisement, or the like.

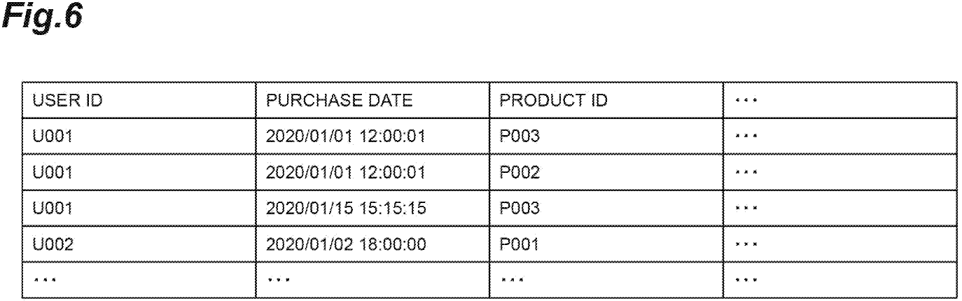

FIG. 6 is a diagram illustrating an example of a configuration of the product purchase log database. The product purchase log database 55 stores information indicating product purchase histories of the users that are analysis targets of the analysis device 10. For example, the product purchase log database 55 stores user IDs which are identifiers for identifying each user and information indicating the product purchase histories associated with the user IDs. The user ID in the product purchase log database 55 may be common to the user ID in the user master database 51. The information indicating the purchase histories may be, for example, the purchase date and time of the product, the product ID, and the like. In an example, the purchase histories may be stored based on data registered in a POS (Point Of Sales) system installed in a retail store. The product ID in the product purchase log database 55 may be common to the product ID in the product master database 52. Furthermore, the information indicating the product purchase histories may include information on the store where the product was purchased, the purchase price, and the like.

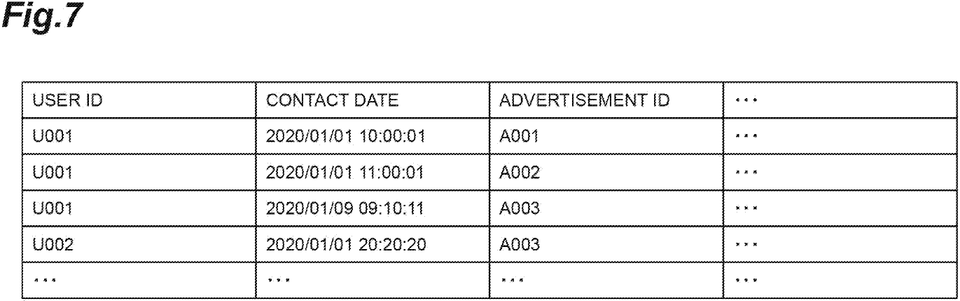

FIG. 7 is a diagram illustrating an example of a configuration of the advertisement contact log database. The advertisement contact log database 56 stores information indicating the browsing histories of the purchases by the users that are analysis targets of the analysis device 10. For example, the advertisement contact log database 56 may acquire information on the browsing from the information terminal device even when the advertisement is browsed by the information terminal device such as a smart phone associated with the user ID. The browsing of the advertisement may be an active click on web banner advertisement by the user, passive display of the advertisement, viewing of video advertisement, or the like. For example, the advertisement contact log database 56 stores a user ID which is an identifier for identifying each user and information indicating the advertisement browsing histories associated with the user ID. The user ID in the advertisement contact log database 56 may be common to the user ID in the user master database 51. The information indicating the browsing histories may be, for example, the contact (browsing) date and time of the advertisement, the advertisement ID, and the like. The advertisement ID in the advertisement contact log database 56 may be common to the advertisement ID in the advertisement master database 53. Furthermore, the information indicating the advertisement browsing histories may include the arrangement of the advertisement on the screen, the URL of the last browsed web page, and the like.

The clustering device 20 has a relationship construction unit 21 and a clustering unit 22. The relationship construction unit 21 constructs the relationship between each product and each advertiser by using the number of common users as the link based on the user purchase histories of the product and the user browsing histories of the advertisement associated with each of the plurality of advertisers. The number of common users is the number of users who have purchased the product for the product and the advertiser linked to each other and have browsed the advertisement associated with the advertiser.

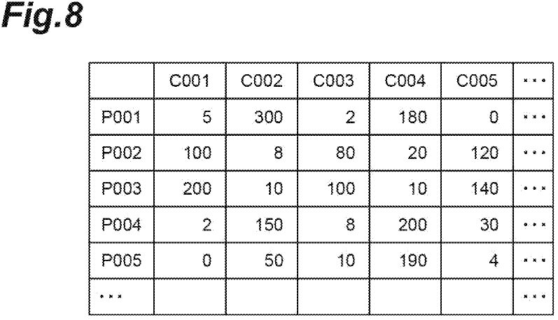

FIG. 8 is a diagram illustrating an example of the relationship between the product and the advertiser constructed by the relationship construction unit 21. An example of the relationship between the product and the advertiser illustrated in the figure is illustrated as a matrix with product IDs in rows and advertiser IDs in columns. The elements of the matrix are the number of common users. That is, the products and the advertisers are linked to each other by the number of common users. An example of the relationship construction unit 21 counts the number of users, as an element, who purchased the product and browsed the advertisement associated with the advertisers for each set of products and advertisers with reference to the advertisement master database 53, the product purchase log database 55, and the advertisement contact log database 56.

For example, as illustrated in FIGS. 6 and 7, the user with the user ID of U001 has purchased the product with the product ID of P003 and is browsing an advertisement with an advertisement ID of A001. In this case, the user with the user ID of U001 is counted to the number of common users (elements) linking the advertiser of the advertisement with the advertisement ID of A001, that is, the advertiser with the advertiser ID of C001 and the product with the product ID of P003. In the example illustrated in FIG. 8, the number of common users for the advertiser with the advertiser ID of C001 and the product with the product ID of P003 is 200. That is, it can be understood that there were 200 users who purchased the product with the product ID of P003 and browsed the advertisement of the advertiser with the advertiser ID of C001.

It is noted that, as illustrated in FIG. 7, the user with the user ID of U001 also browses the advertisement with the advertisement ID of A002 and the advertisement with the advertisement ID of A003. As illustrated in FIG. 5, the advertiser of the advertisement with the advertisement ID of A002 is common to the advertiser of the advertisement with the advertisement ID of A001. In this case, the user with the user ID of U001 is not counted redundantly. On the other hand, the advertiser with the advertisement ID of A003 is different from the advertiser of the advertisement with the advertisement ID of A001 and has an advertiser ID of C002. In this case, the user with the user ID of U001 may also be counted as the number of common users (elements) linking the advertiser with the advertiser ID of C002 and the product with the product ID of P003.

The clustering unit 22 clusters the products and the advertisers together into clusters based on the relationship between each product and each advertiser constructed by the relationship construction unit 21. In one example, the clustering unit 22 clusters the products and the advertisers together into clusters by decomposing the matrix by using matrix decomposition. The matrix decomposition may be a known technique such as non-negative matrix factorization. It is noted that other methods such as Graph (Node) Embedding may be used as the clustering method.

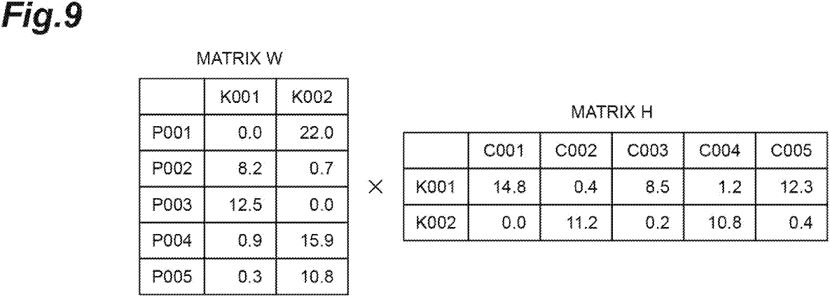

FIG. 9 is a diagram illustrating a decomposition example of the matrix constructed by the relationship construction unit 21. That is, FIG. 9 is the decomposition example of the matrix illustrated in FIG. 8. As illustrated in FIG. 9, the clustering unit 22 decomposes the matrix constructed by the relationship construction unit 21 into a matrix W with the product IDs as rows and a matrix H with the advertiser IDs as columns. That is, a product of the matrix W and the matrix H approximates a matrix constructed by the relationship construction unit 21. The columns of the matrix W and the rows of the matrix H are the IDs of the clusters to be generated. The number of clusters is a parameter set by an administrator of the analysis device 10. The number of clusters can be arbitrarily determined by the administrator. In an example, the number of clusters is less than the number of products and less than the number of advertisers.

For simplifying the description, it is described that the matrix constructed by the relationship construction unit 21 in FIG. 8 has 5 rows and 5 columns. That is, it is assumed that product IDs are P001 to P005 and the advertiser IDs are only C001 to C005. In addition, it is assumed that the cluster IDs are only K001 to K002. With respect to the generated matrix W, the clustering unit 22 allows the product with the product ID to belong to the cluster ID having a maximum value by considering the numerical values (elements) for each product ID in the horizontal direction. In addition, with respect to the generated matrix H, the clustering unit 22 allows the advertiser with the advertiser ID to belong to the cluster ID having the maximum value by considering the numerical values for each advertiser ID in the vertical direction. That is, in the example of FIG. 9, the cluster K001: {P002, P003, C001, C003, C005} and the cluster K002: {P001, P004, P005, C002, C004} are generated. As a result, the analysis target users as a whole has a tendency to browse the advertisements of the advertisers with the advertiser IDs of C001, C003, and C005 when purchasing the products with the product IDs of P002 and P003 and has a tendency to browse the advertisements of the advertisers with the advertiser IDs of C002 and C004 that when purchasing the products with the product IDs of P001, P004, and P005. It is noted that the clustering unit 22 may allow the product with the product ID to belong to a cluster ID having a value of a predetermined threshold value or more. In addition, the clustering unit 22 may allow the advertiser with the advertiser ID to belong to a cluster ID having a value of a predetermined threshold value or more.

The scoring device 30 includes a data creation unit 31, a learning unit 32 and an inference unit 33. The scoring device 30 estimates the users who are likely to purchase a product group constituting the cluster derived by the clustering device 20.

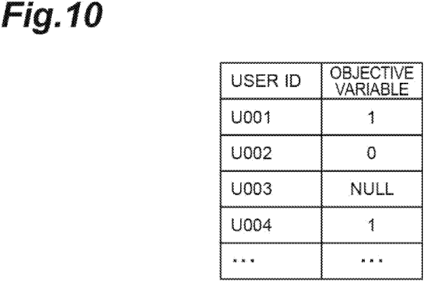

The data creation unit 31 creates data (objective variable) used for constructing a purchase forecast model for estimating the users who are likely to purchase the product group constituting the cluster. The data creation unit 31, as an example, creates data including the objective variable based on the cluster data derived by the clustering device 20 and the data in the product purchase log database 55. FIG. 10 is a diagram illustrating an example of the objective variable created by the data creation unit 31. FIG. 10 exemplifies the objective variable created corresponding to the cluster K001, but similarly, the data creation unit 31 creates the objective variable for other clusters. As illustrated in FIG. 10, for each user ID appearing in the product purchase log database 55, the data creation unit 31 assigns 1 as the objective variable to the case where there is purchase experience for any of the product groups {P002, P003} belonging to the cluster K001. In addition, for each user ID appearing in the product purchase log database 55, the data creation unit 31 assigns 0 the objective variable to the case where there is no purchase experience for any of the product groups {P002, P003} belonging to the cluster K001. Further, the data creation unit 31 assigns NULL as the objective variable for the user IDs not appearing in the product purchase log database 55.

The learning unit 32 creates the purchase forecast model for estimating the users who are likely to purchase the product group constituting the cluster. This purchase forecast model uses the attribute information of the user as an explanatory variable and uses the purchase histories of the product (product group) constituting one cluster as an objective variable. That is, the purchase forecast model may be a model that forecasts what kind of product group a user having what kind of attribute is likely to purchase. The learning unit 32, as an example, acquires the attribute information corresponding to each user ID input from the user master database 51 as the explanatory variable. In addition, the learning unit 32 acquires data including the objective variable created by the data creation unit 31 from the data creation unit 31. The learning unit 32 creates the purchase forecast model based on the acquired explanatory variable and the objective variable.

The learning unit 32, as an example, creates the purchase forecast model based on multiple regression analysis. It is noted that the learning unit 32 is not limited to the multiple regression analysis and may create the purchase forecast model by using known techniques such as decision tree, logistic regression, random forest, gradient boosting decision tree, and the like. For example, the learning unit 32 uses the parameters α, β, and γ to generate an equation such as a model equation for the multiple regression analysis: objective variable = α × {female flag} + β × {20’s flag} + γ × {30’s flag}. The parameters α, β, and γ are automatically determined by the multiple regression analysis. The {female flag} is the explanatory variable that is “1” if the user is a female and “0” otherwise. Similarly, {20’s flag} is the explanatory variable that is “1” if the user is in twenties and “0” otherwise, and {30’s flag} is the explanatory variable that is “1” if the user is in thirties is and “0” otherwise.

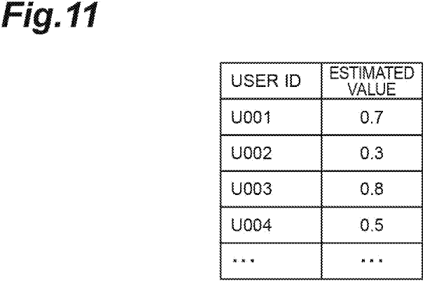

The inference unit 33 uses the purchase forecast model constructed by machine learning to derive the users who are likely to purchase the product group for the product group and the advertiser group constituting one cluster. The inference unit 33, as an example, estimates the users who are likely to purchase the product group based on the purchase forecast model created by the learning unit 32 for the product group belonging to each cluster generated by the clustering unit 22. FIG. 11 is a diagram illustrating an example of an estimation result by the inference unit 33. FIG. 11 illustrates the estimation result of estimating the users who are likely to purchase the product group {P002, P003} belonging to the cluster K001. In this estimation result, it can be said that the closer the estimated value is to “1”, the more likely the users are to purchase the product group {P002, P003} (that is, the product purchase predictive user). The inference unit 33 may derive estimated values for all the users regardless of the objective variable created by the data creation unit 31.

The recommendation device 40 has a recommendation unit 41. The recommendation unit 41 outputs the number of product purchase predictive users for the product group derived by the inference unit 33, the information on products constituting the product group, and the information on advertisers clustered in the product group. The product information can be obtained from the product master database 52. The advertiser information may be obtained from the advertiser master database 54. A product purchase predictive user may be, for example, a user having an estimated value of a predetermined threshold value or more.

In addition, the recommendation device 40 may transmit the number of product purchase predictive users output by the recommendation unit 41 and the information on the products included in the corresponding product group to an e-mail address of a person in charge of the advertiser belonging to the cluster to which the product group belongs. For example, when the analysis is performed for cluster K001, the recommendation device 40 may transmit the product names of the product P002 and the product P003 and the number of purchase predictive users of the products to the e-mail addresses of each person in charge of advertisers C001, C003, and C005.

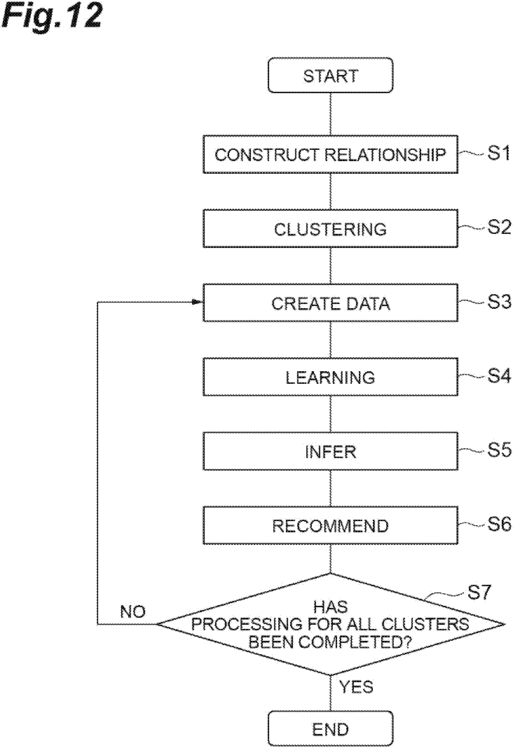

FIG. 12 is a flowchart illustrating an example of an operation flow of the analysis device 10. When the analysis device 10 recommends an appropriate user to an advertiser, first, the relationship construction unit 21 constructs the relationship (a matrix in one example) between the product and the advertiser using the number of common users as a link (step S1). Subsequently, the clustering unit 22 clusters the products and the advertisers together into the clusters based on the constructed relationship between the products and the advertisers (step S2). Subsequently, the data creation unit 31 creates the data (objective variable) used for constructing the purchase forecast model for estimating the users who are likely to purchase the products (product groups) belonging to the cluster (step S3). Subsequently, the learning unit 32 creates the purchase forecast model for estimating the users who are likely to purchase the product group constituting the cluster (step S4). Subsequently, the inference unit 33 derives the purchase predictive user of the product group constituting the cluster based on the purchase forecast model (step S5). Subsequently, the recommendation unit 41 recommends the number of purchase predictive users for the product group derived by the inference unit 33 and the information on the products constituting the product group to the advertisers belonging to the cluster to which the product group belongs (step S6). It is noted that, in step S6, as the information for recommending to the advertiser, the number of purchase predictive users for the product group and the information on the products constituting the product group may be output. Subsequently, it is determined whether or not the processing of steps S3 to S6 has been completed for all the clusters derived in step S2, and when the processing has not been completed (that is, in the case of “NO”), the processing from step S3 to step S6 is executed for the next cluster (step S7). When the processing up to step S6 has been completed for all the clusters (that is, in the case of “YES”), the analysis by the analysis device 10 ends.

In the analysis device 10 described above, since the products and the advertisers are collectively clustered based on the relationship between the products and the advertisers constructed by using the number of common users as the link, the product group can be associated with advertiser group while human knowledge is excluded. In this case, it can be estimated that the users who have purchased a certain product group are interested in the advertisement of the advertiser clustered together with the product group. Therefore, the users appropriate for distribution of the advertisement can be recommended to the advertiser.

In addition, the analysis device 10 may include the inference unit that derives the users who are likely to purchase the product group by using the purchase forecast model constructed by the machine learning for the product group constituting one cluster. This purchase forecast model uses the attribute information of the user as the explanatory variable and uses the purchase histories of the product group constituting one cluster as the objective variable. With this configuration, since the purchase forecast model is constructed by the machine learning for the product group configured with a plurality of the products, compared to estimating the users who are likely to purchase single product, the number of positive examples in the objective variable can be allowed to be increased, so that a more accurate estimation result can be obtained.

The analysis device 10 also includes the recommendation unit that outputs the number of users who are likely to purchase the product derived by the inference unit 33 and the information on the product. By recommending the information on the products included in the product group and the number of purchase predictive users to the advertiser, the advertiser can be allowed to easily consider advertisement placement.

It is noted that the relationship construction unit 21 may acquire the product purchase histories and the advertisement browsing histories of the most recent period of time (for example, about the past few weeks) from the product purchase log database 55 and the advertisement contact log database 56. In this case, by maintaining the freshness of the information on users, it is possible to narrow down the users who are more appropriate targets for the advertisement.

Further, in the data creation unit 31, when the number of purchases per user is a predetermined threshold value or more of 2 or more, 1 may be assigned to the objective variable, and when the number is less than the threshold value 0 may be assigned to the objective variable. By setting the threshold value in this manner, accidental purchases by the user, lack of interest, and the like can be excluded, and thus, the accuracy of the purchase forecast model can be improved.

In the recommendation unit 41, a group of users of which the objective variable in the data creation unit 31 is 1, that is, a group of users who have actually purchased the product may be included in a product purchase predictive user group. In this case, it is possible to construct a user group more appropriate as an advertisement target.

It is noted that the block diagrams used in the description of the above embodiments illustrate blocks in units of functions. These functional blocks (component units) are realized by any combination of at least one of hardware and software. In addition, the method of realizing each functional block is not particularly limited. That is, each functional block may be realized by using one device that is physically or logically coupled and may be realized by connecting directly or indirectly two or more devices that are physically or logically separated (for example, by using wired manner, wireless manner, and the like) by using the plurality of devices. A functional block may be realized by combining software with the one device or the plurality of devices.

The functions include judging, deciding, determining, calculating, computing, processing, deriving, investigating, searching, checking, receiving, transmitting, outputting, accessing, resolving, selecting, choosing, constructing, comparing, assuming, expecting, considering, broadcasting, notifying, communicating, forwarding, configuring, reconfiguring, allocating, mapping, assigning, and the like, but are not limited thereto.

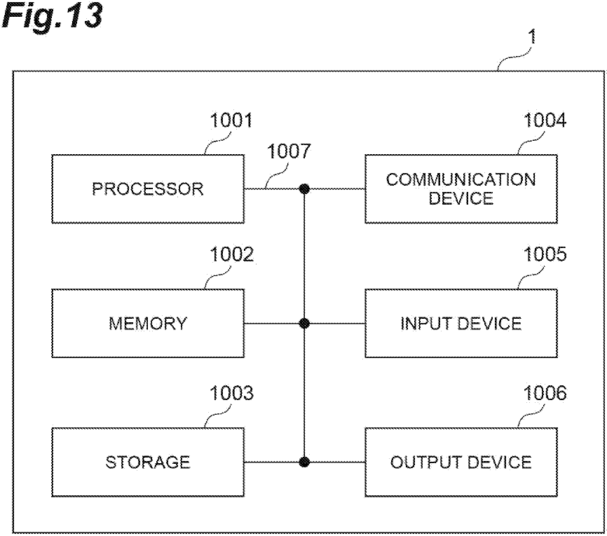

For example, the analysis system 1 (analysis device 10, database device 50) in one embodiment of the present disclosure may function as a computer that performs the method of the present disclosure. FIG. 13 is a diagram illustrating an example of a hardware configuration of the analysis system 1 of the present disclosure. The analysis system 1 described above may be physically configured as a computer device including a processor 1001, a memory 1002, a storage 1003, a communication device 1004, an input device 1005, an output device 1006, a bus 1007, and the like.

It is noted that in the following description, the term “device” can be read as a circuit, a device, a unit, or the like. The hardware configuration of the analysis device 10 may be configured to include one or plurality of the devices illustrated in FIG. 1 and may be configured not to include some of the devices.

Each function in the analysis system 1 is realized by allowing predetermined software (program) to be read on the hardware such as the processor 1001, the memory 1002, allowing the processor 1001 to perform calculations, and controlling communication by the communication device 1004 and is realized by controlling at least one of reading and writing of data in the memory 1002 and the storage 1003.

The processor 1001, for example, operates an operating system to control the entire computer. The processor 1001 may be configured by a central processing unit (CPU) including an interface with peripheral devices, a control device, an arithmetic device, registers, and the like.

The processor 1001 also reads programs (program codes), software modules, data, and the like from at least one of the storage 1003 and the communication device 1004 into the memory 1002 and executes various processes according to these programs, (program codes), software modules, data, and the like. As the program, a program that allows a computer to execute at least a portion of the operations described in the above embodiments is used. For example, the relationship construction unit 21 may be realized by a control program stored in the memory 1002 and operating on the processor 1001 and may be realized similarly in other functional blocks. Although it has been described that the above-described various processes are executed by one processor 1001, these processes may be executed simultaneously or sequentially by two or more processors 1001. The processor 1001 may be mounted by one or more chips. It is noted that the program may be transmitted from a network via an electric communication line.

The memory 1002 is a computer-readable record medium and may be configured with at least one of, for example, a ROM (Read Only Memory), an EPROM (Erasable Programmable ROM), an EEPROM (Electrically Erasable Programmable ROM), a RAM (Random Access Memory), and the like. The memory 1002 may also be called a register, a cache, a main memory (main storage device), or the like. The memory 1002 can store executable programs (program codes), software modules, or the like for implementing a communication control method according to an embodiment of the present disclosure.

The storage 1003 is a computer-readable record medium and may be configured by at least one of for example, an optical disc such as a CD-ROM (Compact Disc ROM), a hard disk drive, a flexible disk, a magneto-optical disk (for example, a compact disk, a digital versatile disk, a Blu-ray (registered trademark) disk), a smart card, a flash memory (for example, a card, a stick, or a key drive), a floppy (registered trademark) disk, a magnetic strip, or the like. The storage 1003 may also be called an auxiliary storage device. The storage medium described above may be, for example, a database, a server, or other appropriate medium including at least one of the memory 1002 and the storage 1003.

The communication device 1004 is hardware (transmitting/receiving device) for communicating between computers via at least one of a wired network and a wireless network and is, for example, also a network device, a network controller, a network card, a communication module, or the like.

The input device 1005 is an input device (for example, a keyboard, a mouse, a microphone, a switch, a button, a sensor, and the like) that receives an input from the outside. The output device 1006 is an output device (for example, a display, a speaker, an LED lamp, and the like) that performs outputting to the outside. It is noted that the input device 1005 and the output device 1006 may have an integrated configuration (for example, a touch panel).

Each devices such as the processor 1001 and the memory 1002 are connected by the bus 1007 for communicating information. The bus 1007 may be configured by using a single bus or may be configured by using different buses between each devices.

In addition, the analysis system 1 may be configured to include hardware such as a microprocessor, a digital signal processor (DSP), an ASIC (Application Specific Integrated Circuit), a PLD (Programmable Logic Device), and an FPGA (Field Programmable Gate Array) and may be configured by realizing a portion or all of functional blocks by the hardware. For example, the processor 1001 may be mounted by using at least one of these pieces of hardware.

Although the present embodiments have been described in detail heretofore, it will be apparent to those skilled in the related art that the present embodiments are not limited to the embodiments described in the present specification. This embodiment can be implemented as modifications and changes in aspects without departing from the spirit and scope of the present invention defined by the description of the claims. Therefore, the description in this specification is for the purpose of illustration and explanation and does not have any restrictive meaning with respect to the present embodiment.

The processing procedures, sequences, flowcharts, and the like of each aspect/embodiment described in the present disclosure may be rearranged in order as long as there is no contradiction. For example, the methods described in the present disclosure propose elements of the various steps by using an exemplary order and are not limited to the specific order proposed.

The Input/output information and the like may be stored in a specific location (for example, a memory) and may be managed by using a management table. Input/output information and the like can be overwritten, updated, or appended. The output information and the like may be deleted. The input information and the like may be transmitted to another device.

The determination may be performed by a value represented by one bit (0 or 1), may be performed by a true or false value (Boolean: true or false), or may be performed by numerical comparison (for example, comparison with a predetermined value).

Each aspect/embodiment described in the present disclosure may be used alone, may be used in combination, or may be used by switching accompanying execution. In addition, the notification of predetermined information (for example, notification of “being X”) is not limited to being performed explicitly, but may be performed implicitly (for example, not performing the notification of the predetermined information).

Regardless of being referred to as software, firmware, middleware, microcode, hardware description language or being referred to as other names, software should be interpreted broadly to denote instructions, instruction sets, codes, code segments, program codes, programs, subprograms, software modules, applications, software applications, software packages, routines, subroutines, objects, executable files, execution threads, procedures, functions, or the like.

In addition, software, instructions, information, and the like may also be transmitted and received via a transmission medium. For example, when the software is transmitted from a website, a server, or another remote source by using at least one of wired technology (coaxial cable, fiber optic cable, twisted pair, digital subscriber line (DSL), and the like) and wireless technology (infrared, microwave, and the like), at least one of the wired technology and the wireless technology is included in the definition of the transmission medium.

Information, signals, and the like described in the present disclosure may be represented by using any of a variety of different technologies. For example, data, instructions, commands, information, signals, bits, symbols, chips, and the like that can be mentioned throughout the above description may be represented as voltages, currents, electromagnetic waves, magnetic fields or magnetic particles, light fields or photons, or any combination thereof.

In addition, the information, parameters, and the like described in the present disclosure may be represented by using absolute values, may be represented by using relative values from a predetermined value, or may be represented by using other corresponding information.

The names used for the parameters described above are not limiting names in any terms. Further, in some cases, the equations, and the like using these parameters may be different from those explicitly disclosed in the present disclosure. Since the various information elements can be identified by any appropriate names, the various names assigned to these various information elements are not limiting names in any terms.

The phrase “based on” used in the present disclosure does not denote “based only on”, unless otherwise specified. In other words, the phrase “based on” denotes both “based only on” and “based at least on”.

Any reference to elements using designations of “first”, “second”, and the like used in the present disclosure does not generally limit the amount or order of those elements. These designations may be used in the present disclosure as a convenient method of distinguishing two or more elements. Thus, reference to first and second elements does not denote that only two elements can be employed or that the first element must precede the second element in any manner.

Where “include”, “including”, and variations thereof are used in the present disclosure, these terms intend inclusive terms such as the term “comprising”. Furthermore, the term “or” as used in the present disclosure is not intended to be an exclusive OR.

In the present disclosure, where articles such as “a”, “an”, and “the” in English have been added by translation, the disclosure may include the plural nouns following these articles.

In the present disclosure, the term “A and B are different” may denote “A and B are different from each other”. It is noted that the term may also denote that “A and B are different from C”. Terms such as “to be separated”, “to be coupled”, may also be interpreted in the same manner as “different”.

### REFERENCE SIGNS LIST

10: analysis device, 21: relationship construction unit, 22: clustering unit, 33: inference unit, 41: recommendation unit.

1. An analysis device comprising:
a relationship construction unit configured to construct a relationship between a product and an advertiser by using the number of common users as a link based on user purchase histories of the product and user browsing histories of an advertisement associated with the advertiser; and
a clustering unit configured to cluster the product and the advertiser together into a cluster based on the relationship between the product and the advertiser constructed by the relationship construction unit,
wherein the number of common users is the number of users purchased the product and browsed the advertisement associated with the advertiser for the product and the advertiser linked to each other.

2. The analysis device according to claim 1, further comprising an inference unit configured to derive the user being likely to purchase the product belonging to the cluster by using a purchase forecast model constructed by machine learning.

3. The analysis device according to claim 2, further comprising a recommendation unit configured to output the number of users being likely to purchase the product derived by the inference unit and information on the product.

4. The analysis device according to claim 2, wherein the purchase forecast model uses attribute information of the user as an explanatory variable and uses purchase histories of a product group configured with the products belonging to the cluster as an objective variable.
